(19) United States
(12) Patent Application Publication
(10) Pub. No.: US 2005/0243410 A1
(43) Pub. Date: Nov. 3, 2005

(54) Optical signal processing device and non-linear optical component

(75) Inventors: Peter Klaus Bachmann, Wurselen (DE); Michel Caron, Aachen (DE); Detlef Uwe Wiechert, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/518,825

(22) PCT Filed: Jun. 19, 2003
(86) PCT No.: PCT/IB03/02767

§ 371 Date: Dec. 21, 2004

(30) Foreign Application Priority Data
Jun. 28, 2002 (DE) 102 29 267.1

(51) Int. Cl. H01S 3/00

(52) U.S. Cl. 359/342

(57) ABSTRACT

An optical signal processing device equipped with a source of electromagnetic radiation of variable intensity, a non-linear optical component, which comprises at least one photoluminescent carbon nanotube, and with a means of detecting electromagnetic radiation utilizes the non-linearity of the photoluminescence of carbon nanotubes for optical signal processing. The invention also relates to a non-linear optical component.

The invention relates to an optical signal processing device, which comprises a source of electromagnetic radiation, a non-linear optical component and a means of detecting electromagnetic radiation and which can be used as photonic component, sensor, optical switch, optical transistor, optical amplifier, optical memory and as optical logic element for an optical computer. The areas of application lie in optical information transmission, sensor systems and integrated non-linear optics.

Non-linear optical components and non-linear optics can be used to construct digital optical memories and logic gates [AND, OR, NOT (Inverter)]. These are, in principle, all the functions that are needed to build an optical computer. It is therefore anticipated that it will in future be possible to build optical computers which work with light pulses rather than electrical current and voltage pulses as in the case of conventional electronic computers. In these supercomputers of the future, light pulses will take over the role of electrons as information carriers.

Conventional optical information transmission systems, such as light-guide systems, also operate with light pulses. In light-guide systems electrical signals are converted into light signals, which pass through the guide system to the receiver, where they are converted into electrical signals or into some other form suitable for the user.

For signal processing in conventional light-guide systems, an optical signal is normally converted immediately on reception via an electro-optical interface into an electrical signal and further processing is then performed by conventional silicon components.

The optical behavior of some materials, such as LiNbO3, is non-linear, i.e. their various optical parameters exhibit a non-linear dependence on one another. Important types of non-linear functions are optical polarization, absorption and refractive index, amplitude modulation of the optical intensity, phase modulation, directional changes and frequency changes.

Non-linear optical components utilize the characteristics of such non-linear optical (NLO) materials and are used as electro-optical interface between optical and electrical information processing. They can amplify incident signals in the same way as transistors or as switches (or gates in a logic circuit) can control the passage of light. In future generations of computers such phototransistors could well play an important role.

Other examples of non-linear, purely optical components are power limiters, oscillators, optical memories, optical sensors and optical switches.

An optical switch is described, for example, in W08900714. W08900714 discloses a switch matrix with optical non-linear, e.g. bistable elements, lying as optically active layers on a common substrate surface, the substrate surface taking the form of a microstructure composed of columns and the optically active layers being applied to the end faces of exposed column ends in a cross-sectional area of columns and/or on those sides of the substrate remote from the columns.

The principle described has the disadvantage that it takes up a relatively large space, as a result of which, in particular, the local resolution of a switch matrix with such optical non-linear elements is limited. The general technical trend, however, is towards further miniaturization from the micro into the nano range.

The object of the invention is to create an optical signal processing device operating in the nano range, which comprises a source of electromagnetic radiation, a non-linear optical component for the switching, amplification, limiting and logic operations and means of detecting electromagnetic radiation.

According to the invention this object is achieved by an optical signal processing device equipped with a source of electromagnetic radiation of variable intensity, a non-linear optical component comprising at least one photoluminescent carbon nanotube, and a means of detecting electromagnetic radiation.

Carbon nanotubes have unique mechanical and electronic characteristics, which make them suitable for nanomechanical and nanoelectromechanical applications, in nanoscalar electronics, for example. To date, however, little has been known about their optical behavior. It has now been surprisingly found that in addition to electroluminescence carbon nanotubes can also exhibit a pronounced photoluminescence.

The present invention is directed towards the use of carbon nanotubes as nano-scalar purely optical modulators in a non-linear purely optical component. It utilizes the way in which the intensity of the luminescent light emitted varies as a non-linear function of the intensity of the electromagnetic radiation, which is used for excitation purposes.

It has surprisingly also been found that after exceeding a threshold value the intensity of the luminescent light increases approximately with the eighth power of the intensity of the exciting electromagnetic radiation.

In the device according to the invention, by varying the input intensity of the electromagnetic radiation carried, the output intensity can be dynamically controlled as a function of the input intensity. The signal processing is therefore here performed by way of the non-linear purely optical component rather than by an electro-optical modulator, so that a purely optical interconnection and hence also purely optical logic circuits are possible with the very high switching speeds associated with these.

According to one embodiment of the invention the non-linear optical component comprises a substrate and a layer having a number of photoluminescent carbon nanotubes.

According to another embodiment of the invention the non-linear optical component comprises a substrate and a layer having a number of photoluminescent carbon nanotubes and also an intermediate layer between the substrate and the layer having a number of photoluminescent carbon nanotubes.

The electromagnetic radiation is preferably monochromatic coherent laser light.

The invention also relates to a non-linear optical component having at least one photoluminescent carbon nanotube.

In the non-linear optical component the carbon nanotube may have a thin film coating.

In the non-linear optical component the carbon nanotube may also be embedded in a non-oxidizing matrix.

In the non-linear optical component the carbon nanotube may be embedded in a non-oxidizing matrix, which is transparent for electromagnetic radiation.

The carbon nanotube may furthermore be embedded in a non-oxidizing, flexible matrix.

The invention will be further described with reference to examples of embodiments shown in the drawings to which, however, the invention is not restricted.

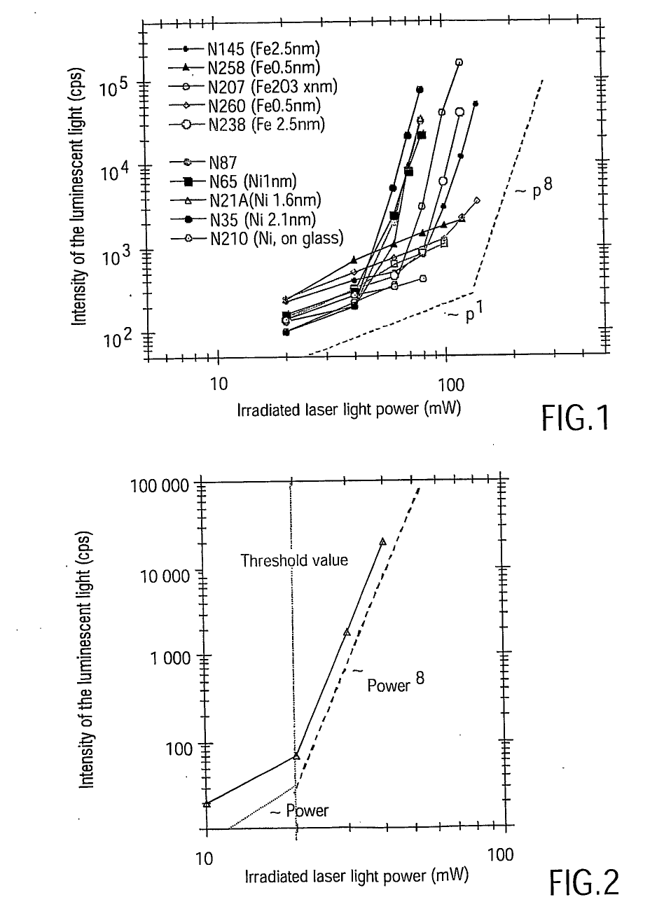

FIG. 1 shows, by way of example, the spectral distribution of the luminescent light from a specimen of carbon nanotubes when excited by a laser light source with a wavelength of 488 nm.

FIG. 2 shows the non-linear intensity amplification of light by carbon nanotubes.

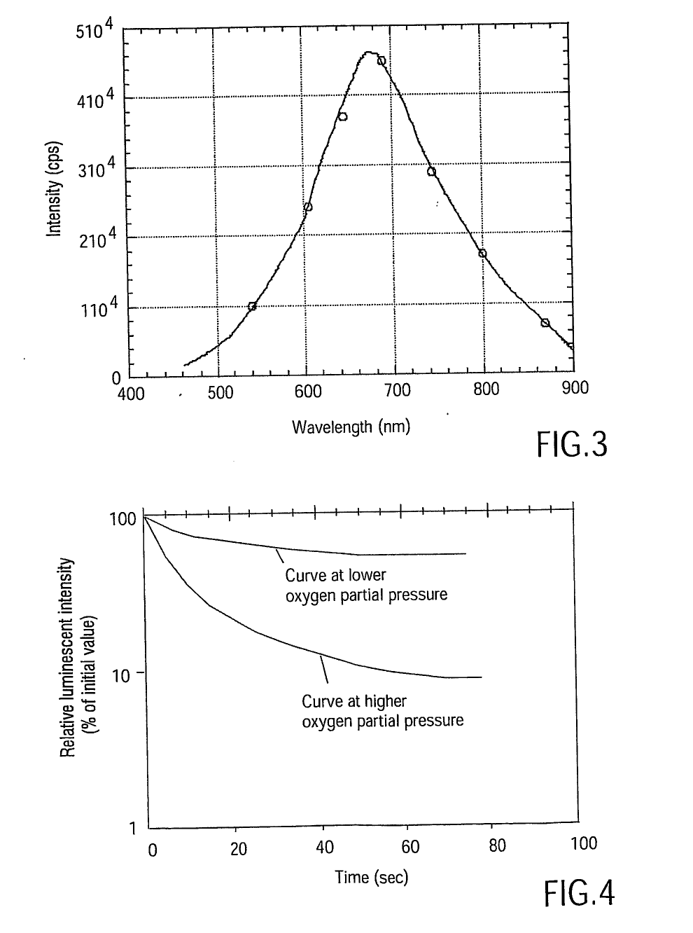

FIG. 3 shows the threshold values of the intensity amplification for some multiwall carbon nanotubes produced by microwave Plasma CVD.

FIG. 4 shows the time curve for the decrease in intensity of the luminescent light emitted under various oxygen partial pressures.

An optical signal processing device according to the invention comprises the following function groups
Generation of electromagnetic radiation,
Non-linear intensity amplification,
Signal reception.
The device can be used to perform the following operations: switching, amplification, limiting and logic operations by means of optical signals.

The term optical signal is understood to mean an electromagnetic pulse with a mean wavelength in the ultraviolet, visible or infrared range of the electromagnetic spectrum.

In order to illustrate the operating principle of the signal processing device with a non-linear optical component, we propose to consider the simplest structure comprising a laser diode, a non-linear optical component and a photodiode.

In a device according to the invention, however, any other suitable light source may also be used as the source of electromagnetic radiation of variable intensity. According to one embodiment of the invention a laser may be used as the source of the electromagnetic radiation of variable intensity. According to another embodiment of the invention the variable intensity is produced by a combination of two conventional lasers. According to a further embodiment of the invention a gas-discharge lamp may be used as the source of the electromagnetic radiation of variable intensity.

Monochromatic coherent laser light is best suited to the transmission and processing of information. The semiconductor materials composed of elements from groups III and V of the periodic table of chemical elements, such as GaAs, GaAlAs, and InGaAsP have energy gaps, which permit the emission of photons in the visible range. Laser diodes composed of one of these materials can be operated with electrical current as energy source. Photon radiation can also be produced by LEDs.

Laser light with an intensity of between 0.1 and 1500 mW is preferably used.

In the laser electrical signals are converted into a photon stream, which is processed in the non-linear optical component and forwarded to the receiver where it is converted back into an electrical signal.

Information is impressed on the laser beam by using an exciting voltage to control the beam intensity, according to a bit pattern, for example.

The electromagnetic radiation incident upon the non-linear optical component is absorbed by the photoluminescent carbon nanotubes and generates, generally with a spectral displacement, photoluminescent light (FIG. 1), which is finally further processed into a photoelectric current.

The wavelength range used is determined by the nanotube material used and by its method of manufacture. In the example of embodiment shown in FIG. 1 this is 700±250 nm.

If, in accordance with the invention, carbon nanotubes with a non-linearity of the photoluminescence are used in a non-linear optical component, this provides a non-linear purely optical component for the aforementioned operations.

The optical non-linear component acts, for example, as a light switch. If the power of a laser beam irradiating such an element increases above a specific threshold value, i.e. the input intensity for the non-linear component increases, this results in an abrupt increase in the light emission. The switching control parameter used is therefore the light intensity Pᵢₙ=σPₒ, which can be obtained, for example, by electro-optical intensity modulation of the electromagnetic input radiation. Pᵢₙ is the intensity of the photoluminescent light, σ the amplification factor and Pₒ the intensity of the input light.

This effect allows such optical non-linear components to be used as switch—elements for purely optical digital data processing.

The degree of optical non-linearity utilizable within the scope of the present invention is remarkable. In the case of known non-linearities, the intensity of the signal emitted increases, by the Kerr effect, for example, proportionally to the cube of the input signal. In the case of the “second harmonic generation (SHG)” a square increase in the intensity of the emitted signal can be observed and utilized. Non-linear optical components with photoluminescent carbon nanotubes can manage with a greatly reduced starting intensity since, as FIG. 2 and 3 show, the intensity of the luminescent light emitted increases with the eighth power of the input optical pulses.

The threshold value for the non-linear amplification to a certain extent depends on the method of manufacture of the carbon nanotubes. FIG. 3 depicts the intensity curve for multiwall carbon nanotubes produced by microwave plasma CVD.

A two-dimensional arrangement of the non-linear optical components is of particular interest, for example, in a switch matrix, in which the individual switch elements have lateral dimensions in the order of 10 μm×10 μm and are as closely adjacent as possible.

On the reception side the system contains an optical receiver, which receives the optical intensity-modulated signal.

Light-emitting diodes and conventional semiconductor diodes can both be used for receiving signals. The photon beam striking a pn-diode excites electrons in the conduction band. At the same time the corresponding number of holes is produced in the valence band. When a voltage is applied a current flows, the strength of which corresponds to the intensity of the incident radiation, and which can be still further amplified.

The basic structure of the non-linear optical component according to the invention may, in principle, comprise a single carbon nanotube. An embodiment comprising substrate, carbon nanotube layer and any intermediate layer is preferred. It may be produced by known methods, preferably by deposition from the gaseous phase by a microwave plasma.

In principle, the non-linear optical component may contain carbon nanotubes in any random orientation. The carbon nanotubes are preferably inserted as a short-walled, regularly deposited layer in order to reduce the light scattering.

The non-linear optical component contains carbon nanotubes. The term nanotubes is generally understood to mean solid, cylindrical discrete fibers with dimensions in the nano range. Carbon nanotubes are hollow carbon fibers having single and multiple wall structures composed of an individually rolled up graphite layer or concentrically arranged graphite cylinders. The graphite layer contains carbon hexagonal rings condensed to one another all round and is rolled up into a cylindrical shape like a honeycomb so that the carbon hexagonal rings are arranged helically.

Inside a layer each carbon atom is cross-linked with three other carbon atoms by sp²-bonds as in graphite, only weak van der Waals forces existing from one layer to the other. Such carbon nanotubes have characteristics both of a metal and of a semiconductor.

Photoluminescent, single-walled carbon nanotubes may be used in the non-linear optical component according to the invention. In the context of the present invention, however, multiwall carbon nanotubes are preferably used.

Multiwall Carbon Nanotubes (MWCNTs) have a layer structure with an envelope composed of a number of continuous concentric layers or shells of sp*2-bonded carbon, which are arranged concentrically around the tube axis. An internal cavity may be more or less pronounced. The shells may have defects such as holes, bond breaks and included foreign atoms.

The precise structure of the multiwall nanotubes is not critical, provided that they are multilayered and have a structure in which the carbon atoms within a layer are linked by sp*2-bonds to form hexagonal rings and from one layer to the other by van der Waals forces.

According to one embodiment of the invention the carbon nanotubes are doped by traces of other elements, in order to influence the optical characteristics.

According to another embodiment of the invention the carbon nanotubes are chemically substituted, in order to influence the optical characteristics.

The carbon nanotubes are preferably inserted as a short-walled, regularly deposited layer in order to reduce the light scattering.

The thickness of the layer containing nanotubes can be adjusted, for example, by purposely etching back with great precision. Nanotube layers with a thickness starting from approximately 5 nm can thereby be achieved. They typically have a thickness from 2 nm to 300 nm, preferably 20 to 50 nm.

Methods for the manufacture of carbon nanotubes are known. They are most easily manufactured on a large scale by an arc discharge between two carbon electrodes.

Other known methods consist of laser vaporization and CVD processes, in particular plasma-based CVD processes.

In the context of the present invention carbon nanotubes which have been deposited by a microwave plasma-based CVD process are preferably used.

The non-linear optical component according to the invention is suitably used as ensemble in a matrix with lateral structuring and is produced accordingly.

In the context of the present invention methods of manufacture in which the nanotubes are directly and regularly deposited on a substrate are preferred for the non-linear optical component.

The manufacture of an oriented array of carbon nanotubes of controlled orientation, diameter, length and shape comprises the following stages: preparation of a substrate, deposition of a catalyst on the substrate, deposition of the nanotubes by thermal separation from a hydrocarbon or by a CVD process on the substrate coated with a catalyst.

According to one embodiment of the invention the substrate is transparent and is composed of quartz, borosilicate or soft glass.

Next a catalyst is applied, which catalyzes the formation of nanotubes from a carbonaceous parent material. Such catalysts include, for example, transition metals, in particular metals from the 8th sub-group of the Periodic System of Elements (PSE) e.g. iron, cobalt, nickel, ruthenium, rhodium, palladium, osmium, iridium and platinum. Metals of the lanthahide and actinide series, and molybdenum are also suitable.

According to one suitable method of manufacture a thin layer of a transition metal composed, for example, of a nickel coating approximately 2 nm thick is applied to a substrate such as silicon or glass. The transition metal may also be deposited in the form of small clusters or single atoms in a wet chemical process.

For the actual manufacture of the carbon nanotubes a carbonaceous parent material and reaction conditions are required, which together with the catalyst cause the carbon nanotubes to grow from a carbonaceous patent material.

The carbonaceous parent material is usually a hydrocarbon with one to seven carbons, e.g. alkanes, alkenes, aryl groups. Methane, ethane, ethylene, ethyne, acetone, propane and propene are particularly suitable.

The most important reaction parameter is the temperature. The thermal energy needed may be supplied in various ways.

The reaction temperature may be between 100 and 1300° C., preferably between 300 and 800° C.

If the carbon nanotubes have not already been deposited on a suitable substrate, they can be formed by the known methods into a layer or be applied as a coating to a substrate.

Possible methods of manufacture include both dry coating processes, such as electrostatic precipitation or electrostatically assisted sputtering, and wet coating processes such as dipping or spraying.

The non-linear optical components can also be arranged as a flat ensemble in the form, for example, of a composite film of a polymer resin with regularly arranged nanotubes.

Polymer resins which are suited to the invention include, for example, acrylic resins, polycarbonate, polystyrene, polyester, epoxy resins, polypropylene resins, polyethylene resins, silicone elastomers, thermoplastic polystyrene and polyolefins and polyurethane.

For example, a suspension of the nanotubes in a binder solution, containing acrylic resins, polycarbonate, polystyrene, polyester, epoxy resins, polypropylene resins, polyethylene resins, silicone elastomers, thermoplastic polystyrene and polyolefins and polyurethane in a non-polar solvent such as N,N¹-dimethyl formamide may be applied to a suitable substrate and then dried to form a composite film.

A further embodiment is preferred, comprising the substrate, carbon nanotube layer and a thin film coating, which protects the carbon nanotubes against oxidation. It is also possible to embed the carbon nanotubes in a solid or flexible layer sufficiently transparent for the exciting and the luminescent light, for example in a glass or in a plastic. These compact layers are also capable of protecting the carbon nanotubes against oxidation. If the carbon nanotubes have no protection or only limited protection against oxidation, the structural changes occurring under light irradiation at a constant intensity of the irradiated light may lead to a more or less rapid decline over time in the intensity of the luminescent light emitted (FIG. 4). Since the time curve for the luminescent light intensity varies as a function of the partial pressure of oxidizing media in the surroundings of the carbon nanotubes, it may be used as an optical measure for the concentration of such media, for example in an optical sensor.

1. An optical signal processing device equipped with a source of electromagnetic radiation of variable intensity, a non-linear optical component, which comprises at least one photoluminescent carbon nanotube, and with a means of detecting electromagnetic radiation.

2. An optical signal processing device as claimed in claim 1, characterized in that the non-linear optical component comprises a substrate and a layer having a number of photoluminescent carbon nanotubes.

3. An optical signal processing device as claimed in claim 2, characterized in that the non-linear optical component further comprises an intermediate layer between substrate and the layer having a number of photoluminescent carbon nanotubes.

4. An optical signal processing device as claimed in claim 1, characterized in that the electromagnetic radiation is monochromatic coherent laser light.

5. A non-linear optical component having at least one photoluminescent carbon nanotube.

6. A non-linear optical component as claimed in claim 5, characterized in that the carbon nanotube has a thin film coating.

7. A non-linear optical component as claimed in claim 5, characterized in that the carbon nanotube is embedded in a non-oxidizing matrix.

8. A non-linear optical component as claimed in claim 5, characterized in that the carbon nanotube is embedded in a non-oxidizing matrix, which is transparent for electromagnetic radiation.

9. A non-linear optical component as claimed in claim 5, characterized in that the carbon nanotube is embedded in a non-oxidizing, flexible matrix.
